(19) United States
(12) Patent Application Publication
(10) Pub. No.: US 2009/0037756 A1
(43) Pub. Date: Feb. 5, 2009

(54) System and Method for Suspending Operation of a Mobile Unit

(76) Inventors: David T. Lundquist, Stony Brook, NY (US); Donald E. Schaefer, Wantagh, NY (US)

Correspondence Address: Fay Kaplun & Marcin, LLP/ Motorola, 150 Broadway Suite 702, New York, NY, 10038, US

(21) Appl. No.: 11/831,007

(22) Filed: Jul. 31, 2007

(51) Int. Cl. G06F 1/32

(52) U.S. Cl. 713/323

(57) ABSTRACT

Described is a method for suspending operation of a mobile unit. Data, settings, an operating system state, and/or at least one application state of a mobile unit is saved to a non-volatile memory. At least one component of the mobile device is deactivated. The mobile unit is placed in a suspend mode.

### FIELD OF THE INVENTION

The present invention relates generally to a system and method for suspending operation of a mobile unit. Specifically, when the mobile unit is suspended, a flash memory is utilized to maintain the device in a suspend mode.

### BACKGROUND

A mobile unit (MU) may utilize a portable power supply such as a battery to provide energy without a need for being connected to an external power supply. The various components of the MU may be powered using the portable power supply. When the MU is in a run state, the MU is fully awake and running at least one user application. Thus, the portable power supply is continually discharging a relatively higher amount of energy. If the MU continues to maintain the run state, the portable power supply will eventually be fully discharged and the MU along with the components are shut down. When the MU is shut down from the portable power supply being fully discharged, any data that has not been stored in memory may be lost or corrupted.

In order to reduce the amount of discharge for the portable power supply, the MU may be equipped with a setting to place the MU in a suspend mode which may be any mode where less power is being consumed than the fully awake running state (e.g., sleep, hibernate, stand by, etc.). In the suspend mode, current data and settings of user applications may be stored in a volatile memory. Furthermore, peripheral components such as a display, a radio, etc. may be deactivated and, therefore, not require any further energy while the MU is suspended. Thus, the portable power supply may discharge at a lower rate. However, due to the memory of the MU being volatile, a continuous supply of energy is required and when the portable power supply has been fully discharged, the data and settings of the user applications may be lost or corrupted.

### SUMMARY OF THE INVENTION

The present invention relates to a method for suspending operation of a mobile unit. Data, settings, an operating system state, and/or at least one application state of a mobile unit is saved to a non-volatile memory. At least one component of the mobile device is deactivated. The mobile unit is placed in a suspend mode.

The present invention also relates to a mobile unit (or a mobile device). The mobile unit includes a battery supplying power to a plurality of components. Each component executes a functionality of the mobile device. The device also includes a volatile memory storing at least one of data and settings relating to a run state and a non-volatile memory storing at least one of data, settings, an operating system state, and at least one application state relating to a suspend mode.

### DESCRIPTION OF THE DRAWINGS

FIG. 1 shows a perspective view of a mobile unit according to an exemplary embodiment of the present invention.

FIG. 2 shows components included in the mobile unit of FIG. 1 according to an exemplary embodiment of the present invention.

FIG. 3 shows a method for placing a mobile unit in suspend mode according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method to place a mobile unit (MU) (or a mobile device) in a suspend mode. Specifically, the exemplary embodiments of the present invention utilize a flash memory to retain data prior to placement of the MU in the suspend mode. As used herewith, the term “suspend mode” may include as a specific mode where the computer core (e.g., processor) may be completely powered off and one or more peripherals may be powered off. Furthermore, the term “suspend mode” may include where the computer core, peripherals, operating system, and user settings may initially be stored on a volatile storage. However, as will be discussed below, the suspend mode may be performed in various other embodiments that have substantially similar results. The MU, the flash memory, and the suspend mode will be discussed in more detail below.

An MU may be equipped with a power management specification. For example, electronic devices such as personal computers may use Advanced Configuration and Power Interface (ACPI). The MU may use a different set of power management rules. The power management specification may allow the MU to be placed in a suspend mode. The suspend mode may include, for example, a sleep mode, a stand by mode, and a hibernation mode. When the MU is placed in the suspend mode, power consumption of a portable power supply such as a battery may be decreased significantly. Prior to placing the MU in the suspend mode, the state (i.e., data and/or settings) of the MU is stored in a memory. It should be noted that the term “settings” used herein may also include, for example, an operating system state and any open application state.

In the case where the data and/or settings are stored in a volatile memory, the portable power supply must continually supply energy to the memory. This continual supplying of energy may eventually drain (e.g., fully discharge) the portable power supply. Furthermore, the power management specification may include an automatic suspend mode activation protocol. Therefore, the portable power supply must reserve a portion of the capacity so that the suspend mode may take place and maintain the suspend mode for a certain duration. For example, twenty percent of the portable power supply may be reserved for emergency suspend mode activation when the portable power supply reaches a threshold minimum capacity. Consequently, a user is only left with eighty percent of the total capacity to utilize the MU in run mode. In addition, despite being placed in the suspend mode, select components of the MU may remain activated to, for example, maintain a network connection, provide a wakeup capability, etc. This may further drain the portable power supply while in the suspend mode. Additional reserves of the portable power supply may be necessary, further decreasing the available capacity to utilize the MU in run mode.

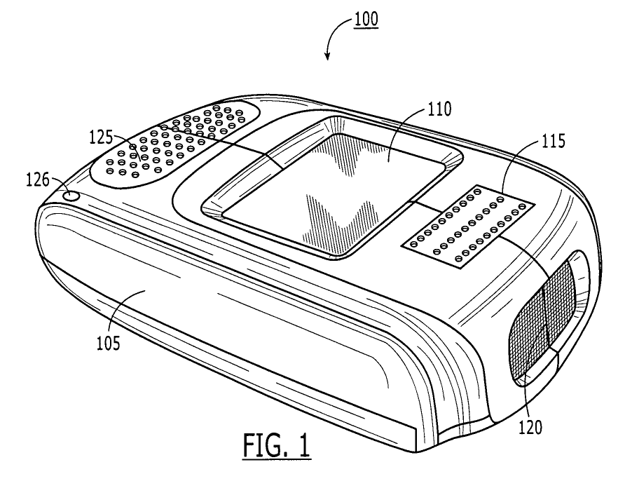

FIG. 1 shows a perspective view of an MU 100 according to an exemplary embodiment of the present invention. The MU 100 may be any device that may utilize a portable power supply such as a battery (e.g., a laptop, a pager, a cell phone, a radio frequency identification device, a scanner, a data acquisition device, an imager, etc.). It should be noted that the term “portable power supply” and “battery” will be used interchangeably in the description below. However, it should also be noted that the portable power supply may encompass other forms of energy storage devices to allow an electronic device to used as an MU (e.g., capacitors, supercapacitors, etc.). The exemplary embodiments of the present invention may also utilize the other forms of energy storage devices.

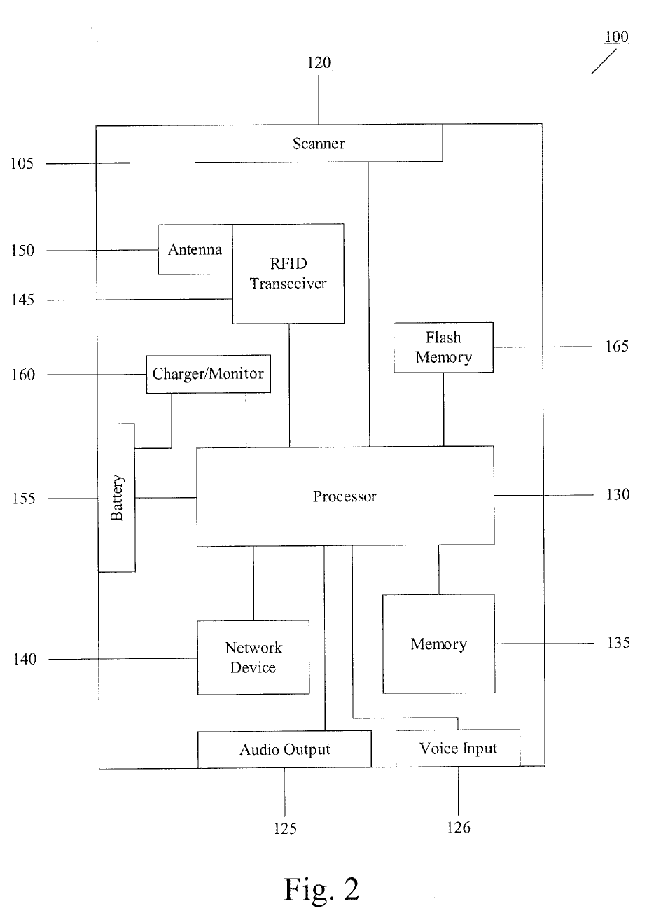

The MU 100 may include a variety of components. As illustrated in FIG. 1, the MU 100 may include a housing 105, a display 110, a data input arrangement 115, a scanner 120, an audio output 125, and a voice input 126. The MU 100 may include further components and functionalities beyond what is illustrated in FIG. 1. These further components and functionalities will be discussed in more detail below with reference to FIG. 2. The MU 100 may also include other components and functionalities such as an expansion port (not shown) to enable a user to insert other hardware devices such as a removable memory device (e.g., a secure digital (SD) card).

The housing 105 may provide a casing for the components of the MU 100. In the exemplary embodiment, the components may be housed within the housing 105 or at least partially on the periphery of the housing 105. For example, the display 110, the data input arrangement 115, the scanner 120, the audio output 125, and the voice input 126 may be housed at least partially on the periphery of the housing 105. The further components may be housed within the housing 105, which will be discussed in more detail below. It should be noted that the display 115, the scanner 120, the audio output 125, and the voice input 126 may be designed using conventional technologies for MUs. It should also be noted that the MU 100 may not include a separate data input arrangement 115. For example, the data input arrangement 115 may be embodied as part of the display 110. That is, the data input arrangement 115 may be touch screen inputs. However, the display 110 may be equipped to receive touch screen inputs and the MU 100 may also have the separate data input arrangement 115. Furthermore, it should be noted that the data input arrangement 115 may be disposed on more than one face of the housing 105. For example, the data input arrangement 115 may include side keypads.

FIG. 2 shows components included in the MU 100 of FIG. 1 according to an exemplary embodiment of the present invention. As discussed above, the MU 100 may also include components within the housing 105. In the exemplary embodiment, within the housing 105, the MU 100 may include the scanner 120, the audio output 125, the voice input 126, a processor 130, a memory 135, a network device 140, a RFID (radio frequency identification) transceiver 145, an antenna 150, a battery 155, a charger/monitor 160, and a flash memory 165. It should be noted that the MU 100 may include further components not shown in the exemplary embodiment. It should also be noted that the components found within the MU 100 are manufactured using conventional technologies but are sized to fit within the housing 105.

In the exemplary embodiment, the scanner 120, the audio output 125, and the voice input 126 may also be at least partially on the periphery of the housing 105 and within the housing 105. The scanner 120 may include circuitry (e.g., scanning engine) that is housed within the housing 105 to protect it from any potential damage. However, the scanner 120 may also include a capturing device (e.g., camera) that requires a line of sight to an object it scans. For example, the scanner 120 may be a bar code scanner or an imager that reads an object. Therefore, a portion of the scanner 120 may be found on the periphery of the housing 105. While the MU 100 is in a run state, the scanning engine of the scanner 120 may continuously be activated, thereby causing a relatively large drain of the battery 155. For example, if the MU 100 is a barcode scanner, a laser may perpetually be transmitted.

The audio output 125 and the voice input 126 may also include circuitry that may be housed within the housing to protect it from any potential damage. The audio output 125 may be a speaker and the voice input 126 may be a microphone. Therefore, including the audio output 125 and the voice input 126 on the periphery of the housing 105 may improve any sound qualities since the sound waves are not required to pass through a barrier (e.g., walls of the housing 105). However, it should be noted that the audio output 125 and the voice input may be found completely within the housing 105 since, unlike the scanner 120, the audio output 125 and the voice input 126 do not require a direct path for incoming and outgoing sound waves.

The processor 130 may be a central computing unit of the MU 100. The processor 130 may be responsible for management of the components of the MU 100. As illustrated in the exemplary embodiment, the scanner 120, the audio output 125, the voice input 126, the memory 135, the network device 140, the RFID transceiver 145, the battery 155, the charger/monitor 160, and the flash memory 165 may be electrically connected to the processor 130. Although the components of the MU 100 may be deactivated, the processor 130 may continuously be active. Thus, as will be discussed in detail below, when the MU 100 is placed in the suspend mode, the processor 130 may be, for example, halted from performing other processes.

The memory 135 may be a storage unit of the MU 100. The processor 130 may access the memory 135 to retrieve or send data. The memory 135 may be a random-access memory (RAM) that includes data that is inputted and retrieved by the processor 130. The memory 135 may be a conventional volatile memory where energy must be continuously provided to retain the data stored therein (e. g., SDRAM).

The network device 140 may be a connection unit of the MU 100. The network device 140 may enable the MU 100 to access a network that is available in an area where the MU 100 is located. In the exemplary embodiment, the network device 140 may wirelessly connect to an available network. However, it should be noted that the network device 140 may connect through physical means (e.g., cables, wires, etc.). In such an embodiment, the network device may include a port (not shown) that is located on the housing 105 to receive a network access cable. The network device 140 may also provide wireless connections such as IEEE 802.11, 802.16, Bluetooth, etc. It should be noted that the MU 100 includes the proper components to allow it to be used as, for example, a cellular phone. Thus, the network device 140 may be used in such a capacity. Due to the size of the MU 100 and the nature of telephone use, a separate antenna may be incorporated to be used with, for example, a wireless headset. However, it is noted that the MU 100 may already include the necessary components to provide telephonic capabilities. In the run mode, the network device 140 may continuously be activated to, for example, maintain a network connection. As will be discussed in detail below, the network device 140 may be one of the selected components of the MU 100 that may still be activated (i.e., powered by the battery 155) during a suspend mode.

The RFID transceiver 145 and the antenna 150 may be units that read RFID tags (i.e., transponders). The RFID transceiver 145 may receive/transmit RFIDs via the antenna 150 from available RFID tags. The RFID tags may be located on various objects. For example, in a warehouse environment, the RFID tag may be on a package. Thus, when a user wearing the MU 100 approaches (passive) or scans (active) the RFID tag with the RFID transceiver 145 via the antenna 150, the RFID may be read and may be, for example, processed by the processor 130 and subsequently stored in the memory 135, sent to the network via the network device 140, etc.

The battery 155 may be a unit that provides the power to the MU 100. The housing 105 may include a panel (not shown) that allows a user to remove/replace the battery 155. The battery 155 may be a rechargeable (i.e., lithium ion) battery. The housing 105 may include a port that receives a recharging unit that recharges the battery 105. The MU 100 may be equipped with the charger/monitor 160 so that the battery 155 is not required to be removed or replaced when the capacity of the battery 155 has been fully discharged or requires recharging. For example, the MU 100 may be placed in a cradle so that electrical contacts (not shown) may couple to corresponding contacts on the cradle to recharge the battery 155 via the charger/monitor 160. The charger/monitor 160 may also provide data pertaining to the battery 155 such as a current capacity, remaining time for using the battery 155, a battery temperature, etc. According to the exemplary embodiments of the present invention, the current capacity of the battery 155 and all derivative data (e.g., remaining time of use) may be relative to a total capacity of the battery. That is, the data that may be determined may not consider a reserve capacity that is necessary. It should be noted that the charger/monitor 160 is only exemplary and the MU may include a separate charger and a separate monitor disposed within the housing 105.

The flash memory 165 may also be a storage unit for the MU 100. Specifically, the flash memory 165 may be a non-volatile storage device. That is, the flash memory 165 may require an initial activation energy in which data is written therein. However, the flash memory 165 may not require additional energy to maintain the data stored therein. In particular, the flash memory 165 may be a NAND (“not and”) flash memory. Those skilled in the art will understand that the NAND flash memory tunnel injection for writing and tunnel release for erasing from the flash memory 165. According to the exemplary embodiments of the present invention, the flash memory 165 may be used to store the data and/or settings of the MU 100 and related programs prior to placing the MU 100 into a suspend mode.

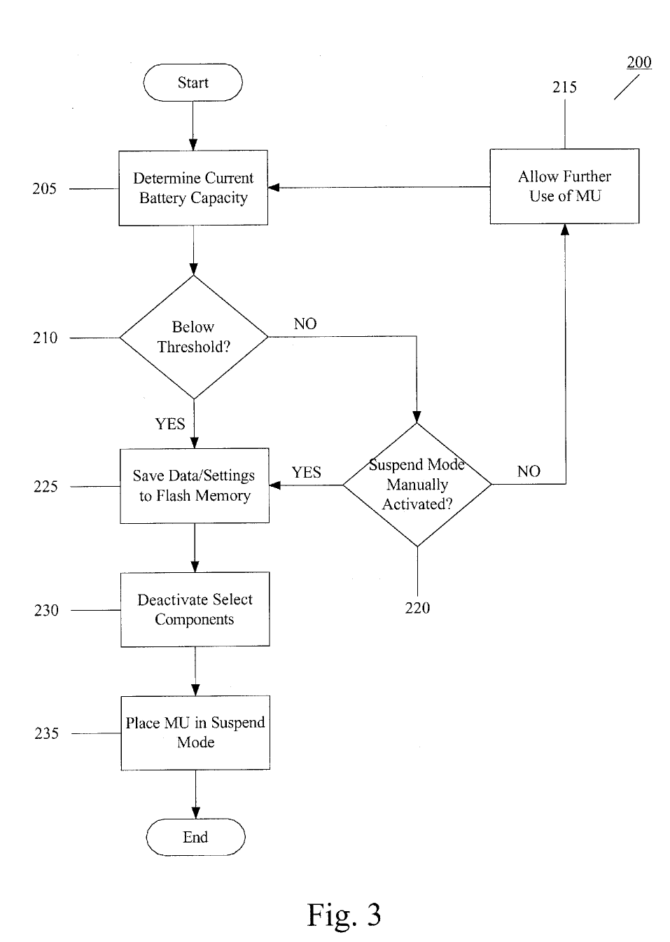

FIG. 3 shows a method 200 for placing an MU in suspend mode according to an exemplary embodiment of the present invention. The method 200 will be described with reference to the MU 100 and the components therein and thereon of FIGS. 1-2. The method 200 may be used to either place the MU 100 in a suspend mode automatically or manually activated by a user. The automatic and manual suspend mode placement will be discussed in further detail below.

In step 205, the current battery capacity is determined. For example, the charger/monitor 160 may make the current battery capacity determination of the battery 155. If the MU 100 includes a power management specification, the specification may indicate that the current battery capacity may be directly related to the automatic placement of the MU 100 in a suspend mode. The determination of the current battery capacity may be relative to a total capacity of the battery 155. That is, the current battery capacity that is determined may not be required to consider a reserve capacity. For example, when all components of the MU 100 are deactivated in the suspend mode, no further computation is required.

In step 210, a determination is made whether the current battery capacity is below a threshold. As described above, the MU 100 may include the power management specification. Thus, when the current battery capacity reaches a minimum threshold, subsequent steps may be taken to ensure that a user's data and/or settings are not lost. The threshold may be related to a determination of which components of the MU 100 are to remain activated. That is, a step may be included between steps 205 and 210 where the processor 130 may determine if select components are to remain active. As will be discussed below, the threshold may be related to a required amount of battery capacity to place the MU 100 in the suspend mode.

If step 210 determines that the current battery capacity is below the threshold, the method 200 continues to step 225. Step 225 will be discussed below. If step 210 determines that the current battery capacity is above the threshold, the method 200 continues to step 220. In step 220, a determination is made whether a suspend mode has been manually activated. For example, a user may wish to place the MU 100 in a suspend mode if the user intends to use the MU 100 at a later time. Thus, the user may forgo any startup sequences as the data and/or settings of the current state may be stored. Furthermore, the user may retain a higher level of battery capacity by leaving the MU 100 in the suspend mode in comparison to continually leaving the MU 100 in a run state.

If step 220 determines that the suspend mode has not been manually activated, the method 200 continues to step 215 where the MU 100 continues in the run state, thereby allowing the user to continue utilizing the MU 100. The method 200 may then return to step 205 where a determination of the current battery capacity is made.

If step 220 determines that the suspend mode has been manually activated or the current battery capacity is below the threshold, the method 200 continues to step 225. In step 225, the data and/or settings of the MU 100 and running programs are stored in the flash memory 165. According to the exemplary embodiments of the present invention, the battery 155 may always have sufficient capacity to place the MU 100 in a suspend mode. One process to placing the MU 100 in the suspend mode is to save any data and/or settings. As discussed above, the writing of the data and/or settings to the flash memory may require a one-time instance of an energy supply from the battery 155.

In step 230, select components of the MU 100 are deactivated. For example, if no component of the MU 100 is required to remain activated during the suspend mode, all the components of the MU 100 may be deactivated. In another example, if a constant network connection is required, the network device 140 may remain activated. Thus, all components other than the network device 140 may be deactivated. In yet another example, the network device 140, the charger/monitor 160, and the audio output 125 may remain activated while the scanner 120, the voice input 126, the processor 130, the memory 135, and the RFID transceiver 145 are deactivated. As discussed above, the components of the MU 100 may be deactivated, but the processor 130 may remain active.

In step 235, the MU 100 is placed in the suspend mode. That is, the processor 130 may be, for example, halted from performing any further processes. As discussed above the MU 100 may be placed in different types of suspend mode (e.g., sleep mode, stand by mode, hibernate mode, etc.). The automatic placement of the MU 100 in the suspend mode may be, for example, a sleep mode. The manual placement of the MU 100 in the suspend mode may be selected by the user. It should be noted that the term “halted” may apply to from a state where the processor 130 has merely stopped performing any further processes to the processor 130 being completely powered down or have the power supply removed.

The exemplary embodiments of the present invention may provide a variety of benefits for placing an MU into a suspend mode. For example, prior to placing the MU into the suspend mode, an energy reserve on the battery may not be necessary. That is, a portion of the battery is not required to be set aside in preparation for an automatic placement of the MU into the suspend mode. Consequently, a greater portion of the battery may be used for the MU during a run state. When the suspend mode does not require any component of the MU to remain activated, a full capacity of the battery may be utilized in the run state.

In another example, the suspend mode may be maintained indefinitely. As discussed above, because the flash memory is a non-volatile storage device, the flash memory does not require additional energy to retain the data written thereon. That is, once data has been written to the flash memory, the data may be accessed at a later time with no energy requirement during the interim. Consequently, when the MU is placed in the suspend mode, the data and/or settings may be written to the flash memory and the data and/or settings may not be lost despite the duration of the suspend mode.

In yet another example, a backup portable power supply found in conventional MUs may be eliminated. When a transition time to place the MU from the run state to the suspend mode is made acceptable short, no further energy may be required to retain the data and/or settings written to the flash memory. Thus, the backup portable power supply may be unnecessary. Consequently, an overall size of the MU may be decreased. Furthermore, the limited pins of a printed circuit board (PCB) in which the processor may be disposed may be freed for other components and functionalities.

It should be noted that the above described exemplary embodiments are only exemplary. For example, the flash memory 165 may be disposed within the housing 105 of the MU 100. However, those skilled in the art will understand that the flash memory 165 may be a separate module that may connect to the MU 100 through, for example, a universal serial bus (USB) port. Thus, the data and/or settings to be stored may be written to the separate flash memory.

In another example, the method 200 may include additional steps. As described above, a step may be included to determine if various components of the MU 100 are to remain activated. The method 200 may also include a step where various components are intentionally deactivated if an automatic suspension of the MU 100 must take place (e.g., when the battery 155 reaches the threshold). For example, the display 110 and the data input arrangement 115 may be deactivated so a user may no longer utilize the MU 100 while the steps to suspend the MU 100 take place. The deactivation of the display 110 and the data input arrangement 115 may also serve to signify to the user that the battery 155 has reached the threshold and the steps to suspend the MU 100 are taking place.

The method 200 may also be modified to include conventional technologies to place the MU 100 in the suspend mode. For example, the MU 100 may proceed with conventional steps to place the MU 100 in the suspend mode. That is, the data and/or settings may be written to the memory 135 (i.e., volatile memory). The charger/monitor 160 may remain activated after the MU 100 is placed in the suspend mode. When the charger/monitor 160 determines that the battery 155 has reached a threshold, the data and/or settings written to the memory 135 may be transferred to the flash memory 165.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
saving at least one of data, settings, an operating system state, and at least one application state of a mobile device to a non-volatile memory;
deactivating at least one component of the mobile device; and
placing the mobile device in a suspend mode.

2. The method according to claim 1, further comprising:
prior to the saving step, determining a current battery capacity of a battery powering the mobile device.

3. The method according to claim 2, further comprising:
comparing the current battery capacity to a threshold.

4. The method according to claim 3, wherein the mobile device is to be placed in the suspend mode automatically when the current battery capacity is below the threshold.

5. The method according to claim 1, further comprising:
prior to the saving, manually activating a process to place the mobile device in the suspend mode.

6. The method according to claim 1, wherein the suspend mode is one of a sleep mode, a stand by mode, and a hibernate mode.

7. The method according to claim 1, further comprising:
determining which components of the mobile device are to remain activated in the suspend mode.

8. The method according to claim 1, further comprising:
initially storing the at least one of the data and the settings to a volatile memory.

9. The method according to claim 8, further comprising:
determining a battery capacity while the mobile device is in the suspend mode.

10. The method according to claim 9, further comprising:
transferring the at least one of the data and the settings stored on the volatile memory to the non-volatile memory when the battery capacity is below a threshold.

11. A mobile device, comprising:
a battery supplying power to a plurality of components, each component executing a functionality of the mobile device;
a volatile memory storing at least one of data and settings relating to a run state; and
a non-volatile memory storing at least one of data, settings, an operating system state, and at least one application state relating to a suspend mode.

12. The mobile device of claim 11, wherein one of the plurality of components is a monitor that determines a current battery capacity of the battery.

13. The mobile device of claim 12, wherein one of the plurality of components is a processor that compares the current battery capacity to a threshold.

14. The mobile device of claim 13, wherein the processor automatically places the mobile device in the suspend mode when the current battery capacity is below the threshold.

15. The mobile device of claim 11, wherein the processor places the mobile device in the suspend mode upon receiving an input indicating a manual placement of the mobile device in the suspend mode.

16. The mobile device of claim 11, wherein the suspend mode is one of a sleep mode, a stand by mode, and a hibernate mode.

17. The mobile device of claim 11, wherein the volatile memory initially stores the at least one of the data and the settings pertaining to the suspend mode.

18. The mobile device of claim 17, wherein one of the plurality of components is a monitor that determines a battery capacity of the battery during the suspend mode.

19. The mobile device of claim 18, wherein the at least one of the data and the settings pertaining to the suspend mode is transferred from the volatile memory to the non-volatile memory when the battery capacity is below a threshold.

20. The mobile device of claim 11, wherein the non-volatile memory is one of a flash memory and a NAND flash.

21. A mobile system, comprising:
a power supply means for supplying power to a plurality of components, each component executing a functionality of the mobile system;
a volatile storage means for storing at least one of data and settings relating to a run state; and
a non-volatile storage means for storing at least one of data, settings, an operating system state, and at least one application state relating to a suspend mode.
